(19) United States
(12) Patent Application Publication
(10) Pub. No.: US 2021/0174387 A1
(43) Pub. Date: Jun. 10, 2021

(54) Vehicle Occupancy Multiple Verification Utilizing Proximity Confirmation

(71) Applicant: RideFlag Technologies Inc., Mississauga (CA)

(72) Inventors: Michel Papineau, Osprey, FL (US); Mark Feltham, Ontario (CA)

(21) Appl. No.: 17/175,916

(22) Filed: Feb. 15, 2021

Related U.S. Application Data
(63) Continuation-in-part of application No. 15/878,217, filed on Jan. 23, 2018, now Pat. No. 10,922,703.

(51) Int. Cl. G06Q 30/02; G07B 15/06; G06K 9/00

(52) U.S. Cl. CPC G06Q 30/0236; G07B 15/06; G06Q 2240/00; G06K 9/00255; G06K 9/00288; G06K 9/00832

(57) ABSTRACT

The present invention is a method and system to verify carpool occupancy compliance for access to High Occupancy Vehicle (HOV) lanes, High Occupancy or Toll (HOT) lanes, or other vehicle-occupancy contingent rewards and other incentives. The present invention uses software and hardware devices with radio-frequency transmitter modules to permit the determination of rewards or incentives based upon meeting thresholds of occupancy, verification of use, or number of points accrued. Occupancy verification is affected by analysis of a single digital image and the application of boxed-head count thereto. The present invention then determines the need for additional occupancy validation. Occupancy compliance rewards can be communicated directly to the driver and riders within a vehicle.

### CLAIM TO PRIORITY

This Non-Provisional application claims under 35 U.S.C. § 120, the benefit as a Continuation In Part of the non-Provisional application Ser. No. 15/878,217, filed Jan. 23, 2018, Titled “Vehicle Occupancy Multiple Verification Utilizing Proximity Confirmation” which is hereby incorporated by reference in its entirety.

### COPYRIGHT AND TRADEMARK NOTICE

A portion of the disclosure of this patent document contains material which is subject to copyright protection. The copyright owner has no objection to the facsimile reproduction of the patent document or the patent disclosure, as it appears in the Patent and Trademark Office patent file or records, but otherwise reserves all copyright rights whatsoever. Trademarks are the property of their respective owners.

### BACKGROUND

More and more Department of Transportation (DOT) jurisdictions seek to create incentives for carpooling such as access to High Occupancy Vehicle (HOV) lanes on public highways. Such HOV lanes permit use only when a vehicle is being used to transport multiple occupants. One of the challenges with dedicating a lane to such “carpooling”, particularly in the introductory phase when there are not many carpoolers, is the resulting, and politically unpopular, increased congestion in the remaining, regular lanes.

To help mitigate this issue, many jurisdictions are introducing HOV lanes as High occupancy OR Toll (HOT) lanes to provide paid access to the lanes for single-occupant vehicles. While paid access to HOT lanes can be less democratic than access to lanes based solely upon occupancy, use of HOT lanes can be more politically acceptable. This is because overall traffic congestion resolution theoretically becomes self-regulating: some drivers will opt to pay a toll to access a reserved lane when congestion is high.

An additional carpooling incentive can take the form of access to private toll roads, with such access also being based upon paid admission. While carpooling can erode the profitability of toll highways, the availability of carpooling on private toll roads can help to alleviate overall traffic volume while simultaneously leading to lower road maintenance and lane expansion costs.

One of the biggest challenges in a DOT/municipality's introduction of a carpool lane is its being able to enforce a carpool occupancy requirement and, in the case of HOT lane access, knowing the identity of the party to be billed for single occupancy access. While technology exists to use photo confirmation to determine occupancy, these technologies often produce questionable confirmations that subsequently require human operator intervention post lane-access. Periodically, such technologies lead to incorrect billing, resulting in a costly and time-consuming review process.

Alternatively, drivers may employ transponder-based systems that require driver input prior to beginning a shared ride. Before approaching a verification point, a driver using a transponder system must remember to indicate carpool activity, usually by activating a switch on his transponder or change settings on their transponder account. In some cases, the driver is required to switch off the transponder to force a “photo exception” to the existing transponder system. This reliance on driver input can lead to system failure in cases where a driver fails to timely or properly indicate carpool activity.

### BRIEF DESCRIPTION OF THE DRAWINGS

Certain illustrative embodiments illustrating organization and method of operation, together with objects and advantages may be best understood by reference detailed description that follows taken in conjunction with the accompanying drawings in which:

FIG. 1 is a system diagram for an exemplary system operation consistent with certain embodiments of the present invention.

FIG. 2 is a process flow diagram for the determination of sufficiency of award criteria using mobile device GPS data and communication of same by server operation consistent with certain embodiments of the present invention.

FIG. 3 is a process flow diagram for verification of vehicle occupancy consistent with certain embodiments of the present invention.

FIG. 4 is a process flow diagram for the determination of sufficiency of award criteria using one or more mobile device digital images and communication of the same by server operation consistent with certain embodiments of the present invention.

FIG. 5 is a process flow diagram for a pre-RealFace-initiation sequence consistent with certain embodiments of the present invention.

FIG. 6 is a process flow diagram for a post-RealFace-initiation sequence consistent with certain embodiments of the present invention.

### DETAILED DESCRIPTION

While this invention is susceptible of embodiment in many different forms, there is shown in the drawings and will herein be described in detail specific embodiments, with the understanding that the present disclosure of such embodiments is to be considered as an example of the principles and not intended to limit the invention to the specific embodiments shown and described. In the description below, like reference numerals are used to describe the same, similar or corresponding parts in the several views of the drawings.

The terms “a” or “an”, as used herein, are defined as one, or more than one. The term “plurality”, as used herein, is defined as two, or more than two. The term “another”, as used herein, is defined as at least a second or more. The terms “including” and/or “having”, as used herein, are defined as comprising (i.e., open language). The term “coupled”, as used herein, is defined as connected, although not necessarily directly, and not necessarily mechanically.

Reference throughout this document to “one embodiment”, “certain embodiments”, “an exemplary embodiment” or similar terms means that a particular feature, structure, or characteristic described in connection with the embodiment is included in at least one embodiment of the present invention. Thus, the appearances of such phrases or in various places throughout this specification are not necessarily all referring to the same embodiment. Furthermore, the particular features, structures, or characteristics may be combined in any suitable manner in one or more embodiments without limitation.

References herein to “device” indicate electronic devices that include but are not limited to, a radio frequency (RF) transmitter, a mobile phone, a laptop, an electronic tablet, or any personal digital assistance device.

References to “verification” indicate an objective process for confirming user input to a device.

References to “validation point” indicate any physical location where a request for verification could logically be made.

References to “rewards” indicate special privileges or access to special privileges that result from successful verification of user input.

References to “photo” or “photograph” indicate a digital visual representation of a vehicle's passenger area.

References to “GPS” indicate reference to the Global Positioning System (GPS) space-based radio-navigation satellite array and associated technologies.

References to “riders” or “multiple riders” in a vehicle refers to 2, 3, or more riders depending upon the capacity of the vehicle.

Urban and suburban dwellers often seek shared transportation options for reasons as diverse as economy in travel expenses, shared responsibility in vehicle operation, and human companionship during a commute. In metropolitan areas where traffic congestion is rife, local authorities often incentivize shared transportation options in order to relieve traffic congestion and reduce expensive road maintenance. Setting aside special travel lanes for multi-occupant “carpooling” vehicles is one such incentive that municipalities employ. Vehicles with certain established occupancies are permitted unfettered access to lesser-travelled High Occupancy Vehicle (HOV) or High Occupancy/Toll (HOT) lanes, theoretically minimizing travel delays due to traffic congestion. Such delay minimization is a coveted reward for those who choose to carpool.

Because of the desirability of designated HOV and HOT lane access, municipalities prefer to adopt systems and procedures to track, prevent and manage abuse of such lane access. Existing systems of ensuring compliance with rules regarding High Occupancy lane access rely on self-reporting, photographic verification, or post-billing adjudication.

Drivers and riders who wish to carpool may not know of each other or may not share compatible commuting schedules. For instance, even if two commuters are aware of each other, a vehicle driven by Driver A and bound for mid-town at 6:00 am may not prove a suitable match for Rider B needing to arrive in mid-town at 6:00 pm. Consequently, a need exists for a system and method for verifying carpool compliance using software and hardware devices that permit “matchmaking” between suitable drivers and riders while confirming passenger proximity to a driver.

In an embodiment, the invention described herein is a mobile-device application that uses user interfaces and GPS software to provide a list of prospective drivers with known travel itineraries to any number of potential riders. Riders can flag drivers based upon criteria such as exactness of itinerary match and prior rider reviews of drivers. Drivers can accept or reject specific riders as matches.

In an embodiment, co-location verification of a driver and all riders within a vehicle takes place at a temporal validation point to gather evidence as to the physical location of the device. The driver's GPS coordinates are known to the application (app), since the driver keeps his app open for the duration of a trip. A first server compares the GPS data from both devices and if resulting comparison evidences co-location of devices, the co-location is considered to be verified. Confirmation of such verified co-location can then be submitted to appropriate regulatory bodies for the doling of a reward, such as permitted HOV or HOT access, or permitted preferred parking, or other rewards that may be provided by the transportation authority or additional entities partnering with the transportation authority. The system in in its entirety is referred to as the RideFlag® application.

The RideFlag® system offers a robust, data/rules-based reward system based on a set of parameters defined within the system. The reward system parameters may include defined occupancy, distance, locations, and/or other requirements that trigger one or more rewards or incentives once the defined system parameter has been met. In an exemplary embodiment, the system may provide an incentive for pre-set vehicle occupancy thresholds, where the system may provide an incentive upon verifying the presence of 1, 2, 3 or more occupants in the vehicle. Another incentive may be triggered based upon the proximity of the carpool location to a defined reward point. The system may trigger an incentive based upon the proximity to the driver at the end of a trip. In a non-limiting example, the distance proximity to a driver is useful for college or university campuses where a rider may get dropped at a campus location and the driver proceeds on to another physical location to park the vehicle. The system may also trigger an incentive based upon a total carpool distance travelled as a minimum threshold. In a non-limiting example, a total carpool distance threshold of 50 miles may be set to trigger an incentive.

Additional incentives or rewards may require membership in an organization known as RideFlag circles. The organization membership is required of some or all participants to receive some rewards that have been established for members. The system may also have a set number as a maximum number of rewards to grant. The maximum number of rewards may be associated with a time span, such as weekly or monthly, to individuals, or set as an overall maximum. Rewards may be offered to a driver or to riders within the same vehicle, or to all participants within a registered vehicle. External requirements such as the vehicle also being registered with a parking or highway facility, such as, in a non-limiting example, a registered permit holder or transponder account holder. In partnership with one or more external groups, such as, in a non-limiting example, a university, parking authority, highway authority, or other partner, may validate any external requirements at the time the RideFlag system makes an API call to the partner system with the required information. The parameters identified and configured within the system server give reward grantors a complete set of variables to provide compelling incentives while controlling any reward offering exposure and limiting “cheating”, where “cheating” may be defined as a driver or rider attempting to ask for or demand a reward or incentive where the conditions for receiving a reward or incentive have not been met.

Some highway system operators offer different rewards depending on the number of people carpooling at the time of the reward. As a non-limiting example, the express toll highway operator, 95 Express between Fort Lauderdale and Miami, requires 3 or more people carpooling to qualify for toll exemption. Other highway system operators may offer a 50% discount for 2 people and 100% exemption for 3 or more. System operators finally may use “dynamic” pricing to determine the rates based on current demand to help control the flow of traffic.

The RideFlag system dynamically evaluates and verifies the number of occupants in a vehicle at the time of the reward request through an App on a mobile phone or other mobile device at various trigger points during the travel of each vehicle registered with the RideFlag system. In an exemplary embodiment, the verification is usually triggered by the vehicle passing into or through a geo-fenced area. When a reward event is triggered, the RideFlag system server verifies the number of occupants in or near the vehicle and ensures that the rules set by the parameters are all met in order to grant the reward. Verifying the occupancy of the individuals in the vehicle may be a process of counting the number of heads in identification boxes shown in an image captured by an image capture device, such as a camera, or may include a more elaborate identification procedure as discussed further in this document.

In an embodiment, while transponders identify the vehicle, the RideFlag® system identifies vehicle occupancy and location. In an embodiment, the RideFlag® system confirms the presence of two or more occupants within a single vehicle when drivers and riders use the application on HOT lanes, even for free rides with no other incentive than access to the HOV/HOT lane toll free. The RideFlag® system provides the platform to collaborate with jurisdictions, Toll Highway operators, and other partners to confirm occupancy.

The RideFlag® validation system accounts for all RideFlag® participants involved in the carpool/vanpool. The system has the ability to validate the location of every participant at the time of each reward granting opportunity and as such we can offer our very robust incentive structure.

In an exemplary embodiment, riders and drivers may use the RideFlag® application to establish carpools on an as-needed basis with no carpool registration required. The RideFlag® system is totally dynamic in that carpools are created and identified at the singular transaction level. In a non-limiting example, a carpool can exist for a single instance of a paired ride, as well as for other groups of riders and lengths of rides. The identification of the carpool is automatically known by the RideFlag® system. In this exemplary embodiment, the platform identifies the occupants, the route and time of access. The RideFlag® server may then publish this confirmation to each of the relevant highway operators immediately post the access, complementing the existing photo confirmation systems and eliminating the need for human confirmation for RideFlag® application users.

Once drivers and riders have accepted matches, each is notified of the location of the other through use of GPS data associated with the driver's and rider's mobile devices. Once drivers and riders are physically within one vehicle, the GPS data can be analyzed to verify co-location of the driver and rider(s).

In an embodiment, rewards and/or incentives offered to users of the RideFlag® system may include preferred parking at a variety of facilities. The preferred parking spaces are reserved spaces at the best points of egress and are generally the most desired parking spots. As a qualifying vehicle enters the proximity of one of these facilities, our system reaches out to the partner system tracking and managing the parking space inventory to ensure the requirements are currently met for granting the parking upgrade.

In an embodiment, rewards and/or incentives offered to users may also include Special highway lane access. Several toll segments and toll express lanes offer incentives for carpooling (this is especially relevant on highways operated by government agencies). Lanes that have a toll designed less for revenue and more for regulating traffic flow are referred to as “managed lanes”; and in these lanes carpooling is especially relevant as carpooling directly reduces the number of cars causing the congestion that requires management. On these highways, government operators are highly motivated to grant toll-free access to confirmed multiple occupant vehicles. In verifying that a vehicle is eligible to receive such rewards or incentives, the government operators must dynamically determine whether any vehicle qualifies for toll exemption, or discount, based upon occupancy. Additionally, even though riders are motivated to find others with whom to carpool, it is difficult for even motivated commuters to find others who would like to carpool to take advantage of the managed lane toll-free access for carpooling.

In an embodiment, the RideFlag® system dynamic carpooling and validation capability conquers both the challenge of verification of vehicle eligibility and finding motivated commuters with whom to carpool by offering participants an easy way of identifying the most appropriate partners to carpool with and dynamically validating their carpool with the toll operator system to grant the toll-free award.

In an embodiment, the RideFlag® system may identify and grant other rewards or incentives that are based upon points earned during system use. Such points-based rewards may include merchandise, entertainment and direct cash from transportation operators. Additionally, participating corporate citizens interested in reducing congestion and employers who want to reduce their parking requirements for employees may provide points-based rewards and offer these rewards through the RideFlag® system to qualified users.

In an embodiment, the invention described herein is a method of verifying commuter vehicle occupancy by establishing communication between a RideFlag® server and one or more mobile devices, determining the physical locations of each of said mobile devices, verifying said mobile devices are co-located, determining whether said proximity conforms to one or more pre-determined values, delivering communications from the server to a secondary server, such as, in a non-limiting example, one operated by or on behalf of a regulatory body, governmental entity or transportation authority, and delivering communications from the server to said mobile devices. Verification of vehicle occupancy may be affected through analysis of one or more photographic representations of the vehicle passenger compartment.

In an alternate embodiment of the invention, a system of verifying commuter vehicle occupancy is described. The system may include a user interface, a server having a processor in wireless communication with one or more mobile devices, and a software module operative to determine the physical locations of the mobile devices. In use, the server verifies co-location of the mobile devices, delivers communications from the server to a secondary server (like one operated by or on behalf of a regulatory body), and delivers communications from the server to a user interface display on any one of the mobile devices.

The system and method described herein identifies vehicle occupancy and location as a natural product of the RideFlag® transportation application. The application confirms the presence of two or more occupants when drivers and riders simply use the app to match prospective drivers with prospective riders. When used with respect to HOT or HOV lane access, RideFlag® provides the platform to collaborate with jurisdictions and Toll Highway operators to confirm vehicle occupancy.

In an alternative embodiment, the RideFlag® application may permit the use of free or discounted access to HOT lanes to vehicles in which there is only one verified person based upon special considerations. Such special considerations may include, but are not limited to, premium access based upon a specified number of paid uses of the HOT lane, special discounts for particular dates or times, a reward offered by the operator of the HOT lane, or any other special consideration defined by the authority operating the HOT lane. In a non-limiting example, a vehicle with a single driver may be permitted to use the HOT lane after accumulating 10 authorized uses of the HOT lane, meeting all conditions of such use. Additionally, an authority operating a HOT lane may permit use of the HOT lane to single driver vehicles, or vehicles that do not meet all of the conditions for use of a particular HOT lane, to users with a mobile device in the vehicle that has been certified as having a special premium established by the authority operating the HOT lane even though the user of the mobile device in the vehicle may not be the driver of the vehicle.

In an embodiment, the instant innovation validates the number of people within a vehicle by analyzing a single image, captured by a single camera. In this embodiment the captured image may be either a photograph or a non-photograph image sent by a camera associated with a smart phone, car camera, or other image capture device. The instant innovation analyzes the captured image for human faces within the image where each human face is identified as being within an image-superimposed box that surrounds the human face in the captured image. In an embodiment the instant innovation may place identified human face images within image-superimposed boxes and then perform a “quick count” of the number of boxes. Such “quick count” serves as a fast validation of the count of individual persons within a vehicle. The “quick count” process may be performed when validation is required at a time when a vehicle is at a validation point for a reward. The “quick count” process is performed each time a validation is required, however, when a trip audit is requested or necessary the “quick count” process is further augmented with a more comprehensive validation. Additionally, when a “quick count” validation is insufficiently accurate such as, in a non-limiting example, when light levels are too low to render the visual image in sufficient detail, and when a deeper analysis is required, the instant innovation may perform a trip audit as well.

The trip audit's deeper validation for those situations where an audit is required, or the accuracy of the “quick count” review is non-determinative, consists of an analysis of each of the faces contained within the image-superimposed boxes to calculate a facial signature for each head. In an embodiment, the parameters of such facial signature are determined by the relative positions of an individual human's facial features, such as, by way of non-limiting example, eyes, nose, and mouth, to one another. In the event that the system's application of image-superimposed boxes has inexactly differentiated individual human heads, facial signatures are not distinctive enough, or simply as an initial analysis, the instant innovation's use of a computer program entitled “RealFace” determines the presence of individual faces within a single visual image through a process of facial image differentiation.

In an embodiment, the system's use of “RealFace” to perform facial image differentiation includes masking of features (including, in a non-limiting example, masking of the lower half of a human face), identification of micro-movements, and observation of gross and micro-movements indicating positional changes for the persons within the image to determine one unique human being from another.

Validation of persons within a vehicle may proceed from a count of boxed face views within an image (“boxed heads”), to validation through a facial signature, to full validation for all persons within an image through facial image differentiation utilizing the “RealFace” image analysis software. This three-tier process for identification of persons within a vehicle to validate ridership within a vehicle may also present an opportunity to verify the identities of the persons within the vehicle as being distinct individuals and may indicate who those persons are in certain circumstances.

In an embodiment, the system may review captured images that do not have a high image quality. For those images having a poor image quality, the system may apply filters and other image enhancement techniques to reduce distortion and compensate for other image parameters to ensure that the faces captured in an image are the faces of real human riders. In addition, the system may be capable of analyzing images that have been captured with a three-dimensional image capture device, such as, in a non-limiting example, a 2-lens camera installed within a smart device such as a smart phone. The three-dimensional image may present a topographical image for analysis by the system. The topographical image may provide additional assurance of the validity of the persons captured in the image as being images of real persons.

In an embodiment, the instant innovation may calculate a user “trust score” which indicates the level of compliance of the driver of a vehicle, or the individual claiming a reward, with following the rules in the past.

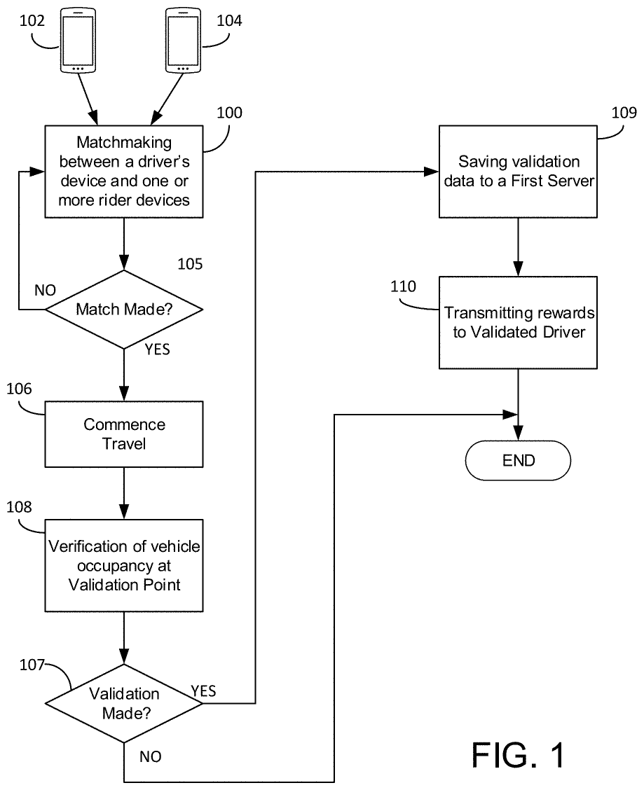

Turning now to FIG. 1, a system diagram for an exemplary system operation consistent with certain embodiments of the present invention is shown. During matchmaking 100, driver's device 102 and rider's device 104 are paired based upon data provided by the users of the devices, such as destination, desired times of departure and arrival, and fee amounts. Once paired 105, driver's device 102 and rider's device 104 enter commence travel phase 106. Commence Travel phase 106 includes driver and rider meeting in physical space and beginning travel to a mutually-agreed upon destination. Upon reaching discrete validation points 108, driver's device 102 and rider's device 104 are triggered by a first server 109 to provide first server 109 with GPS coordinates to determine whether devices are co-located. If the devices associated with the driver and one or more riders are determined to be co-located at 107, and if first server 109 determines that reward requirements are met, first server 109 confirms reward status with second server (owned or controlled by the reward grantor, such as a regulatory agency, transportation authority, or a partner to these entities) and with at least driver's device 102. Upon confirmation of the reward status, rewards may be transmitted to a driver 110.

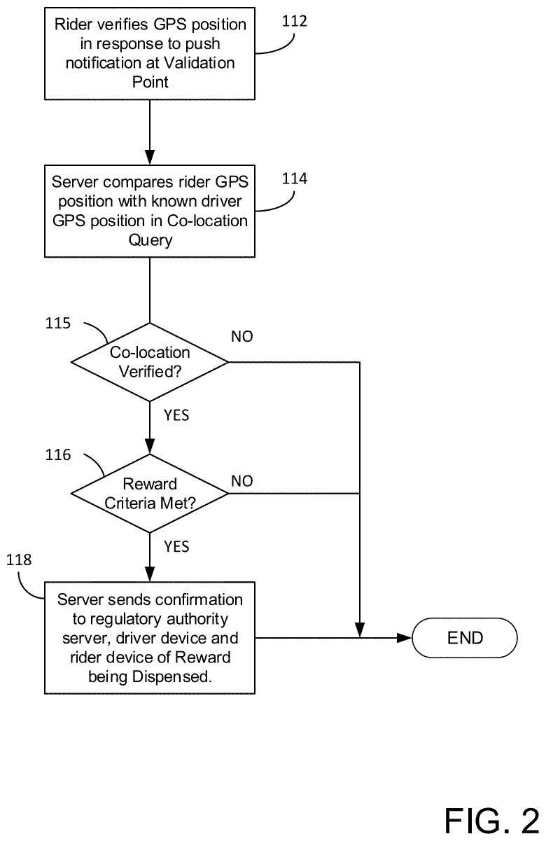

Turning now to FIG. 2, a process flow for the determination of award criteria consistent with certain embodiments of the present invention is shown. In an embodiment, a rider verifies his GPS coordinates at a validation point 112. At 114, the system server compares rider's GPS coordinates to driver's known GPS coordinates. From this information, the server may determine if the driver and rider(s) are currently co-located 115. At 116, the server determines if the necessary reward criteria have been met. Most commonly, reward criteria would involve the number of occupants in a car associated with a time of day. The number of occupants in a car may be determined by the number of RF signals detected at a validation point, or by photo evidence provided by any one of the detected mobile devices associated with an RF signal that is collocated with the driver's mobile device. At 118, the server sends determination regarding satisfaction of reward criteria to the appropriate regulatory authority, transportation authority or partner, the rider(s), and the driver.

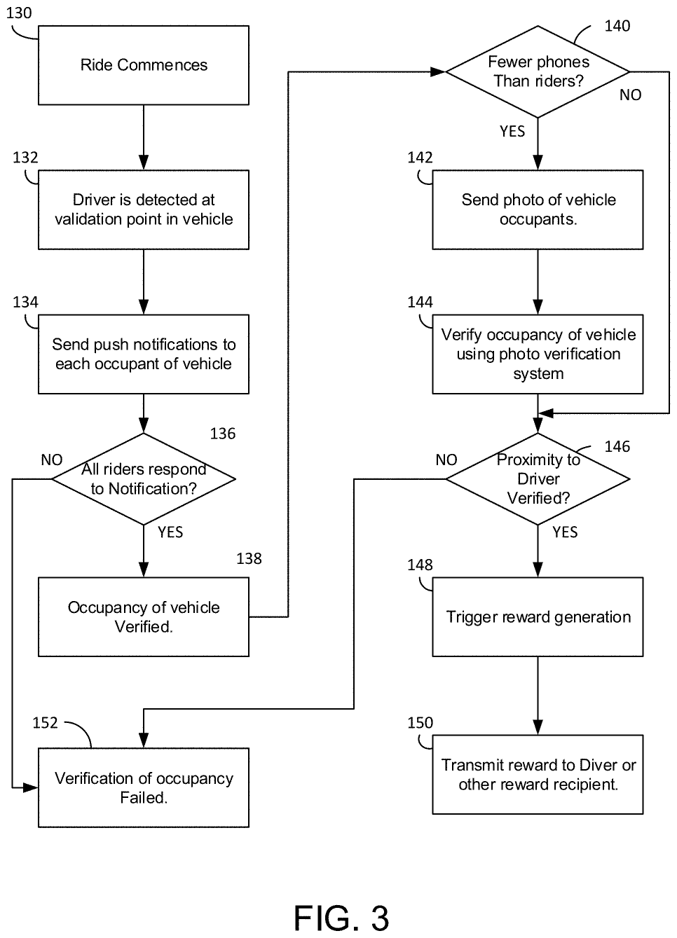

Turning now to FIG. 3, a process flow diagram for verification of vehicle occupancy is shown. In an embodiment, at 130, the ride commences, with the driver and rider beginning the trip to any reward point or rider destination. At 132, the driver's device comes within detection distance of a validation point which may then trigger a server request for verification of the number of car occupants. In a non-limiting example, such a validation point would typically be positioned immediately prior to HOV or HOT lane access. In the case where the reward is a preferred parking spot instead of special lane access, the validation point may be positioned at a parking lot entrance or parking garage entrance.

In an embodiment, at 134, in cases where the number of RF transmitter-equipped devices (i.e.: smartphones, or other RF transmitting devices) equals the number of individuals collocated in a vehicle, which includes the driver and all riders, the first server sends a push notification to each individual to provide notification of a verification action. GPS coordinates of the location of each RF transmitter-equipped device are collected by the RideFlag system. This response from each individual device permits the RideFlag® server to determine the device proximity, and, by extension, the rider proximity, to the driver of the vehicle. At 136, if all riders are determined to be within a set distance that indicates they are close enough to the driver that they are within the driver's vehicle, the RideFlag® system may verify that the occupancy requirements have been met for the driver's vehicle 138. These responses provide for the verification of the number of riders within the vehicle and provide a verification step for occupancy in the vehicle.

In an embodiment, at 140, in cases where the number of RF transmitter-equipped devices is smaller than the number of riders, a different method of verification may be required. In this exemplary embodiment, one of the riders (passengers) may be instructed to send a photo of vehicle occupants time-stamped with the time of the driver's device that triggered the verification request at the encountered validation point 142. Uploading the time-stamped photo to the server permits the photo verification of the number of occupants in a vehicle utilizing existing photo verification systems 144. The server may utilize the photo verification of the occupants of the vehicle to provide the occupancy verification step for the vehicle.

In this exemplary embodiment, at 146, if the first server determines that the driver and the riders have met occupancy requirements by verifying the proximity of each occupant to the driver of the vehicle, a reward may be triggered 148. If the first server determines that the driver and riders have failed proximity requirements, a failure notice is triggered. If the reward grantor suspects that the driver has falsified the proximity requirements the server may label this action as “cheating” the system. In a non-limiting example, and not by way of limitation, one condition the server may label as “cheating” may be using multiple phones not associated to physical individuals to attempt to establish that there are an equal number of RF-transmitting devices and individuals collocated within a single vehicle. If the server determines that an action or activity that may be labeled as “Cheating” has occurred, the server may require the performance of a dual validation activity, such as requiring both GPS push notification responses and photo identification. At 146, the server performs dual validation with post-event reply requests during a time interval when it would be unlikely or illogical for two or more devices associated with separate, physical individuals to be co-located.

At 150, if the reward grantor is satisfied that that the occupancy of the vehicle has been properly verified, and that the driver is not “cheating” in some fashion, the reward grantor may then transmit the reward certificate, notification, validation, or permission to the driver of the vehicle.

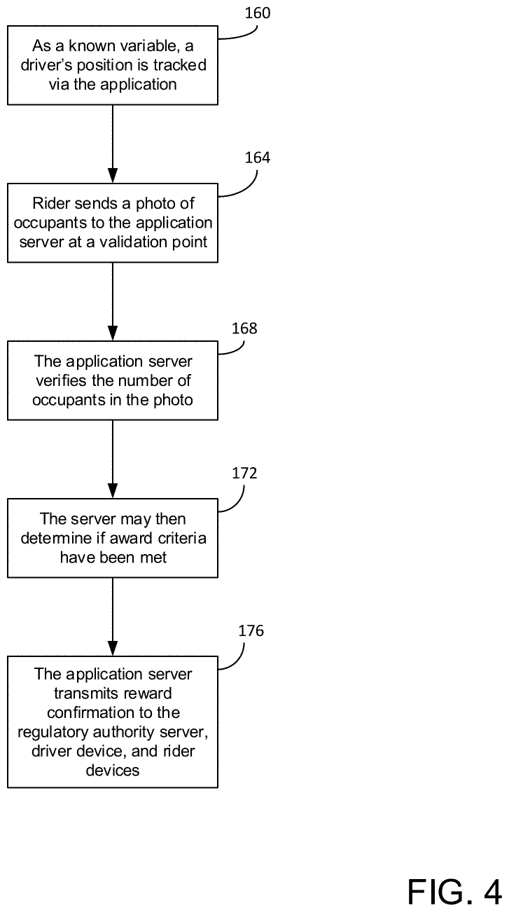

Turning now to FIG. 4, a process flow for an alternate determination of award criteria consistent with certain embodiments of the present invention is shown. In an embodiment, a device having an RF transmitter and associated with a driver communicates its physical location to an application server at 160. At 164, a rider sends a verification photo of all vehicle occupants to the application server from the GPS coordinates corresponding to a validation point. At 168, the application server determines the number of occupants that are present in the vehicle in the verification photo. At 172 the application server determines if the number of occupants satisfies the reward criteria. At 176 the application server sends a determination regarding satisfaction of reward criteria to the appropriate regulatory authority, transportation authority or other authorized entity, the rider, and the driver. The regulatory authority, transportation authority, or other authorized entity may then issue a certificate or any other verification acknowledgement instituted for use by the issuing authority that the reward will be provided to a person associated with the vehicle, where the person associated with the vehicle may include a driver, a rider, or other authorized person such as, in a non-limited example, the owner of the vehicle.

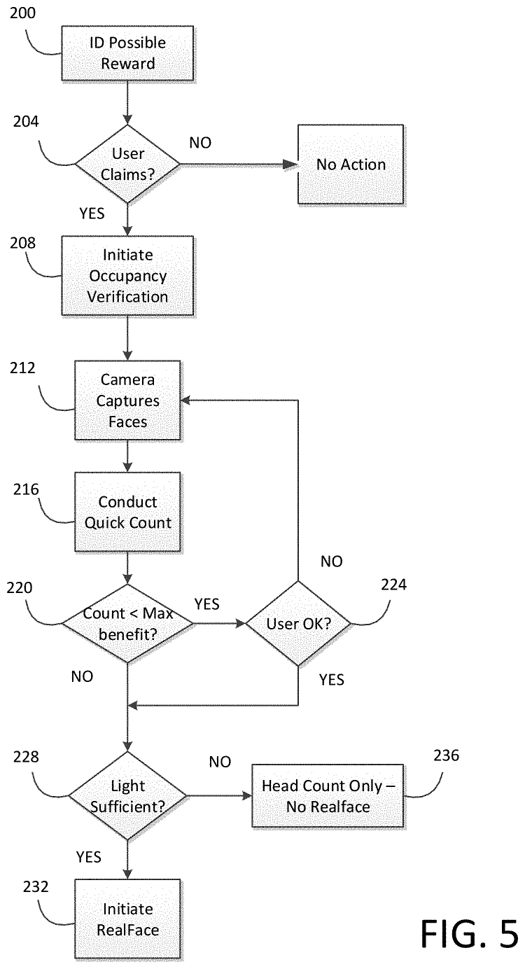

Turning now to FIG. 5, a process flow diagram for a pre-RealFace-initiation sequence consistent with certain embodiments of the present invention is shown. At 200 the system works to identify a reward for which the user may qualify. In an embodiment, the reward is an incentive to the user to commute with multiple people in a single vehicle. In an embodiment, the user can proactively prompt the system to search for reward validation points or the user's device may utilize an automatic listener to search for reward validation points. Automatic listener may be employed, in a non-limiting example, when the system is connected to the car's BlueTooth communications system. At 204 the user may claim a reward presented pursuant to a system prompt. In a non-limiting example, such a system prompt may be, “To qualify for toll-free access, your vehicle must have three occupants. Do you want to claim this reward?” In a non-limiting example in which the proffered reward is graduated rather than binary in nature, the system prompt may be, “To qualify for a 50% fee reduction, your vehicle must have two occupants. To qualify for toll-free access, your vehicle must have three occupants. Do you wish to claim this reward?” If at 204 the user elects not to claim the reward, the system continues to identify possible rewards at 200. If at 204 the user elects to claim the reward, then at 208 the system initiates verification of the vehicle occupancy. In a non-limiting example, the system prompts the user to have a passenger hold a camera in such a manner to capture at least all passenger faces. In an embodiment, the camera may be mounted on the dashboard in landscape orientation or the camera may be held by a passenger in landscape orientation at a point in the vehicle which allows the camera to capture the faces of every occupant of the vehicle. In an embodiment the face of the driver will be determined as such by its position in the camera capture and the driver will not be required to face the camera. Once the driver's face is identified as such, the system pre-supposes the driver's face to be an actual single human face and will not consider the driver's face as requiring the application of the

### RealFace Verification Program.

At 212 the camera captures the faces of the occupants of the vehicle and the system at 216 conducts a boxed-head “quick count” to determine the number of vehicle occupants which are candidates for Realface verification, and displays the “quick count” to the user. At 220 the system determines if the “quick count” number is below the minimum number required for the maximum offered reward for the occupants. If at 220 the “quick count” number is sufficient for the user to claim the maximum offered reward, then at 228 the system determines whether there is sufficient ambient light in the vehicle for the system to perform RealFace verification. If at 220 the “quick count” number is below the minimum number required for the maximum reward, then at 224 the system prompts the user to indicate whether the user wishes to collect the reward based upon that “quick count” number. If the user does not wish to proceed based upon that number, then the system re-initiates camera face capture at 212. If the user does wish to proceed based upon that number, then at 228 the system determines whether there is sufficient ambient light in the vehicle for the system to perform RealFace verification. In an embodiment, the system determines the sufficiency of ambient light by referencing the user's device history for ambient light luminosity. If the device history shows sufficient luminosity, then at 232 the system initiates RealFace verification. If the device history shows insufficient luminosity, then at 236 the system proceeds to evaluate the grant of the reward based upon the available head count and does not initiate a Realface algorithm verification count.

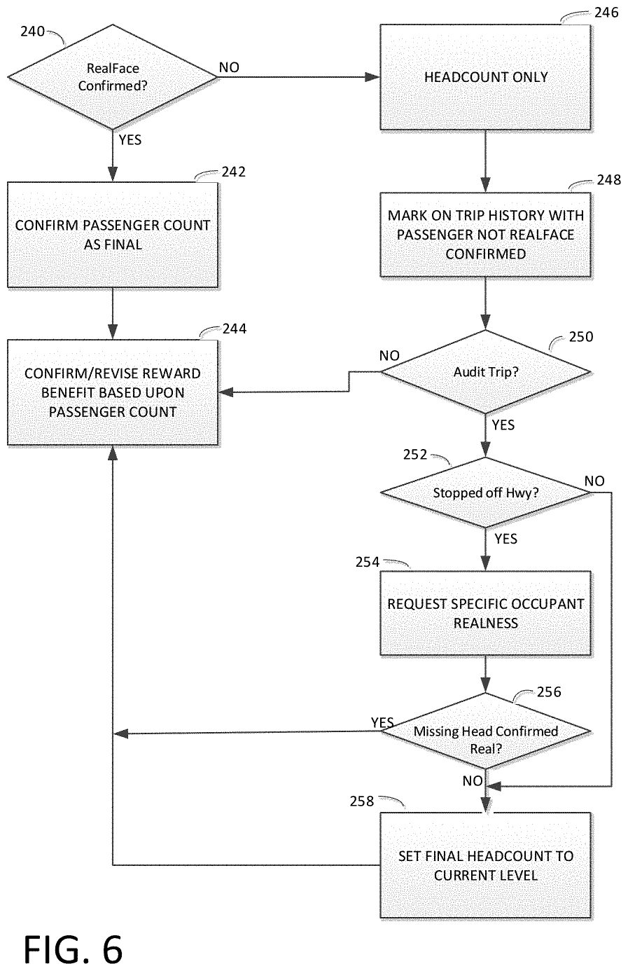

Turning now to FIG. 6, a process flow diagram for a post-RealFace initiation sequence consistent with certain embodiments of the present invention is shown. At 240 the system returns an initial RealFace determination as to whether the faces presented to the system as real are analyzed to be real human faces, providing confirmation for all individuals within a vehicle. If at 242 the system confirms that all of the presented faces within the analyzed image are real, then at 244 the system reports a validated face count for all individuals within the captured image. Also, at 244, the system may confirm the reward benefit due to any or all individuals within the captured image, or may revise the reward benefit actively in response to the number of confirmed and/or counted individuals within the vehicle.

If at 242 the system does not determine that all of the presented faces are real, then at 246 the system determines whether any exemptions to RealFace determination apply. In a non-limiting example, the driver of the vehicle is considered exempt from Realface determination. The system is then active to perform a headcount of individuals within a captured image. At 248 the system ride history for that particular ride is updated to record that at least one passenger within the vehicle, as shown by the head views in the captured image, has not been confirmed as real through the use of the

### RealFace Determination.

If at 250 the system determines that any exemptions apply, and that the number of exemptions accounts for any discrepancy in RealFace reporting, then the system reports the validated face count at 244. If at 250 the system does not determine the presence of sufficient exemptions or if the trip is marked as an audit trip, then the system initiates an audit of the number of occupants in the vehicle. The system may also randomly initiate an audit absent the determination of any discrepancy. The system may initiate such a random audit at any time including, but not necessarily limited to, the point at which facial images are first presented to the system. At 252 the system will determine whether the vehicle is currently in motion on the highway or other road.

If the vehicle is current in motion and not stopped off of the highway, the system will not attempt further validation but may at 258 set the final headcount for the vehicle on that particular trip at the current headcount level.

At 254, with the vehicle stopped by the side of the highway or road upon which the vehicle is travelling, the system may introduce additional attempts to confirm actual faces within the vehicle by requesting a lighting condition change followed by a recapture of the image with all passengers captured in a single image under the new lighting conditions. The system will attempt to confirm and validate as real any heads within the image that have not been previously confirmed or exempted through the analysis of the image utilizing the digital facial signature calculated for each head view within the newly captured image. At 256, if the validation attempt for any head view that was captured in the image but was not previously validated is successful, then the system reports a validated face count at 244 and revises or confirms any reward available to the passengers within the vehicle for that trip.

If the attempt at 256 is not successful, then at 258 the system sets the final headcount to the current level. Once again, the system reports a validated occupant count at 244 and confirms and/or revises the reward benefit due to any individual passenger within the vehicle for this trip based upon the final headcount captured and validated within the captured image. Otherwise, at 272 the system returns the confirmed head count, regardless of value, as the verified head count.

While certain illustrative embodiments have been described, it is evident that many alternatives, modifications, permutations and variations will become apparent to those skilled in the art in light of the foregoing description.

We claim:

1. A method of verifying commuter rewards based upon vehicle occupancy, comprising:
establishing communication between a server and one or more mobile devices;
capturing a digital image including multiple human faces utilizing a single image capture device;
applying a count algorithm to count the number of human heads in said digital image;
confirming the number of actual human faces at least in part from the determined number of human heads;
determining if a pre-set condition or threshold has been met;
triggering the award of an incentive or reward based upon at least one pre-set condition and/or threshold; and
delivering said incentive or reward from the server to said one or more mobile devices for access and use of the owner of any one of said one or more mobile devices.

2. The method of claim 1, where the single digital image is either a photograph or an image sent to the server by said image capture device.

3. The method of claim 1, where the boxed head count does not require the calculation, determination, or analysis of a facial signature.

4. The method of claim 1, where the boxed head count requires the calculation, determination, or analysis of a facial signature.

5. The method of claim 1, where the determination of said incentive or reward is based at least in part on the vehicle, driver, and/or riders meeting a pre-set threshold condition.

6. The method of claim 1 where said multiple human faces are verified through the process step of facial image differentiation.

7. The method of claim 1, where determining the need for verification of that number of actual human faces is at least in part a function of the historical compliance of said mobile device users as indicated by a trust score.

8. The method of claim 7, where the verification of the number of actual human faces permits delivery of the reward and/or incentive to the one or more users associated with said one or more mobile devices and where the reward and/or incentive is activated for the benefit of said one or more users.

9. The method of claim 1, where the single image capture device is a camera.

10. A system of verifying commuter vehicle occupancy, comprising:
a server having a processor in wireless communication with one or more mobile devices;
a user interface active on the said one or more mobile devices and associated with users;
capturing a digital image including multiple human faces utilizing a single image capture device;
said server applying an algorithm to count the number of human heads appearing in said digital image;
said server confirming the number of actual human faces at least in part from the count of the number of human heads in said digital image;
said server determining if a pre-set condition or threshold has been met;
said server triggering the award of an incentive or reward based upon at least one pre-set condition and/or threshold; and
said server delivering said incentive or reward from the server to said one or more mobile devices for access and use of the owner of any one of said one or more mobile devices.

11. The system of claim 10, where the single digital image is either a photograph or an image sent by a camera associated with an image capture device,

12. The system of claim 10, where the boxed head count does not require the calculation, determination, or analysis of a facial signature.

13. The system of claim 10, where the boxed head count requires the calculation, determination, or analysis of a facial signature.

14. The system of claim 10, where the determination of said incentive or reward is based at least in part on the vehicle, driver, and/or riders meeting a pre-set threshold condition.

15. The system of claim 10, where the multiple purported human faces consist of actual human faces or actual human faces and representations of actual human faces.

16. The system of claim 10, where determining the need for verification of that number of actual human faces is at least in part a function of the historical compliance of said mobile device users as indicated by a trust score.

17. The system of claim 16, where the verification of the number of actual human faces permits delivery of the reward and/or incentive to the one or more users associated with the mobile devices and where the reward and/or incentive is activated for the benefit of said users.

18. The system of claim 10, where the single image capture device is a camera.
